(19) United States
(12) Patent Application Publication
(10) Pub. No.: US 2018/0217286 A1
(43) Pub. Date: Aug. 2, 2018

(54) SELECTING LOGGING DATA FOR PETROPHYSICAL MODELLING AND COMPLETION OPTIMIZATION

(71) Applicant: HALLIBURTON ENERGY SERVICES, INC., Houston, TX (US)

(72) Inventors: Mehdi Eftekhari FAR, Humble, TX (US); John Andrew QUIREIN, Georgetown, TX (US); Jim Michael WITKOWSKY, Houston, TX (US); Daniel Robert BULLER, Shreveport, LA (US); Milos MILOSEVIC, Houston, TX (US)

(73) Assignee: HALLIBURTON ENERGY SERVICES, INC., Houston, TX (US)

(21) Appl. No.: 15/736,390

(22) PCT Filed: Jul. 20, 2015
(86) PCT No.: PCT/US2015/041081

§ 371 Date: Dec. 14, 2017

(51) Int. Cl. G01V 1/50; G01V 11/00

(52) U.S. Cl. CPC G01V 1/50; G01V 2210/74; G01V 2210/612; G01V 11/002

(57) ABSTRACT

Systems and methods for selecting the best logging data for petrophysical modelling and completion optimization by analyzing sensitivity and errors in the logging data.

### FIELD OF THE DISCLOSURE

The present disclosure generally relates to systems and methods for selecting logging data for petrophysical modelling and completion optimization. More particularly, the present disclosure relates to selecting the best logging data for petrophysical modelling and completion optimization by analyzing sensitivity and errors in the logging data.

### BACKGROUND

Many statistical approaches are used to select valid log measurements, also known as logging data, for evaluating geomechanical properties and formation evaluation. Sometimes, however, these methods show inconsistent results. For this reason, it is believed that a combination of log measurements have to be acquired, at a minimum, for evaluating geomechanical properties and formation evaluation. Moreover, conventional approaches used to select valid log measurements for field development and formation evaluation do not use stepwise regression to select valid log measurements and reliably evaluate geomechanical properties and formation evaluation.

### BRIEF DESCRIPTION OF THE DRAWINGS

The present disclosure is described below with references to the accompanying drawings in which like elements are referenced with like reference numerals, and in which:

FIG. 1 is a flow diagram illustrating one embodiment of a method for implementing the present disclosure.

FIG. 2A is a log plot illustrating interpreted logging data from the Eagle Ford formation that may be used as input in step 104 of FIG. 1.

FIG. 2B is a log plot illustrating interpreted logging data from the Haynesville formation that may be used as input in step 104 of FIG. 1.

FIG. 3A is a graph illustrating the correlation coefficient plotted in step 110 of FIG. 1 for the Eagle Ford formation.

FIG. 3B is a graph illustrating the correlation coefficient plotted in step 110 of FIG. 1 for the Haynesville formation.

FIG. 3C is a graph illustrating the correlation coefficient plotted in step 110 of FIG. 1 for the Middle East formation.

FIG. 3D is a graph illustrating the correlation coefficient plotted in step 110 of FIG. 1 for the Barnett formation.

FIG. 4A is a graph illustrating the RMSE plotted in step 110 of FIG. 1 for the Eagle Ford formation.

FIG. 4B is a graph illustrating the RMSE plotted in step 110 of FIG. 1 for the Haynesville formation.

FIG. 4C is a graph illustrating the RMSE plotted in step 110 of FIG. 1 for the Middle East formation.

FIG. 4D is a graph illustrating the RMSE plotted in step 110 of FIG. 1 for the Barnett formation.

FIGS. 5A-5F are graphs illustrating the interpreted logging data and the respective predicted interpreted logging data from the Haynesville formation plotted in step 112 of FIG. 1 for FI, as a function of depth, on a separate graph for each type of original logging data and combination of logging data types (i.e. SGR; GR, DTC; SGR, DTC; GR, DTC, DTS; SGR, DTC, DTS; and SGR, DTC, DTS, NPHI, RHOB (ALL LOGS)).

FIGS. 6A-6F are graphs illustrating the interpreted logging data and the respective predicted interpreted logging data from the Eagle Ford formation plotted in step 112 of FIG. 1 for PI, as a function of depth, on a separate graph for each type of original logging data and combination of logging data types (i.e. SGR; GR, DTC; SGR, DTC; GR, DTC, DTS; SGR, DTC, DTS; and SGR, DTC, DTS, NPHI, RHOB (ALL LOGS)).

FIGS. 7A-7F are graphs illustrating the interpreted logging data and the respective predicted interpreted logging data from the Haynesville formation plotted in step 112 of FIG. 1 for PI, as a function of depth, on a separate graph for each type of original logging data and combination of logging data types (i.e. SGR; GR, DTC; SGR, DTC; GR, DTC, DTS; SGR, DTC, DTS; and SGR, DTC, DTS, NPHI, RHOB (ALL LOGS)).

FIGS. 8A-8F are graphs illustrating the interpreted logging data and the respective predicted interpreted logging data from the Eagle Ford formation plotted in step 112 of FIG. 1 for TOC, as a function of depth, on a separate graph for each type of original logging data and combination of logging data types (i.e. SGR; GR, DTC; SGR, DTC; GR, DTC, DTS; SGR, DTC, DTS; and SGR, DTC, DTS, NPHI, RHOB (ALL LOGS)).

FIGS. 9A-9F are graphs illustrating the interpreted logging data and the respective predicted interpreted logging data from the Haynesville formation plotted in step 112 of FIG. 1 for TOC, as a function of depth, on a separate graph for each type of original logging data and combination of logging data types (i.e. SGR; GR, DTC; SGR, DTC; GR, DTC, DTS; SGR, DTC, DTS; and SGR, DTC, DTS, NPHI, RHOB (ALL LOGS)).

FIGS. 10A-10F are graphs illustrating the interpreted logging data and the respective predicted interpreted logging data from the Haynesville formation plotted in step 112 of FIG. 1 for PHIE, as a function of depth, on a separate graph for each type of original logging data and combination of logging data types (i.e. SGR; GR, DTC; SGR, DTC; GR, DTC, DTS; SGR, DTC, DTS; and SGR, DTC, DTS, NPHI, RHOB (ALL LOGS)).

FIGS. 11A-11F are graphs illustrating the interpreted logging data and the respective predicted interpreted logging data from the Eagle Ford formation plotted in step 112 of FIG. 1 for DF, as a function of depth, on a separate graph for each type of original logging data and combination of logging data types (i.e. SGR; GR, DTC; SGR, DTC; GR, DTC, DTS; SGR, DTC, DTS; and SGR, DTC, DTS, NPHI, RHOB (ALL LOGS)).

FIGS. 12A-12F are graphs illustrating the interpreted logging data and the respective predicted interpreted logging data from the Haynesville formation plotted in step 112 of FIG. 1 for DF, as a function of depth, on a separate graph for each type of original logging data and combination of logging data types (i.e. SGR; GR, DTC; SGR, DTC; GR, DTC, DTS; SGR, DTC, DTS; and SGR, DTC, DTS, NPHI, RHOB (ALL LOGS)).

FIG. 13 is a block diagram illustrating one embodiment of a computer system for implementing the present disclosure.

### DETAILED DESCRIPTION OF THE PREFERRED EMBODIMENTS

The present disclosure overcomes one or more deficiencies in the prior art by providing systems and methods for selecting the best logging data for petrophysical modelling and completion optimization by analyzing sensitivity and errors in the logging data.

In one embodiment, the present disclosure includes a method for selecting logging data for petrophysical modelling and completion optimization, which comprises: i) determining a preferred set of original logging data from original logging data using stepwise regression and a computer processor to predict interpreted logging data for the original logging data; ii) determining a correlation coefficient and a root-mean-square error (RMSE) for each type of original logging data and combination of original logging data types in the preferred set of original logging data using interpreted logging data for the preferred set of original logging data and the predicted interpreted logging data for the preferred set of original logging data; iii) plotting each correlation coefficient and RMSE on a separate graph for each type of original logging data and combination of original logging data types in the preferred set of original logging data; iv) plotting the interpreted logging data and each respective predicted interpreted logging data, as a function of depth, on a separate graph for each type of original logging data and combination of original logging data types in the preferred set of original logging data; and v) selecting a best set of original logging data in the preferred set of original logging data based on one or more of the plotted graphs.

In another embodiment, the present disclosure includes a non-transitory program carrier device tangibly carrying computer executable instructions for selecting logging data for petrophysical modelling and completion optimization, the instructions being executable to implement: i) determining a preferred set of original logging data from original logging data using stepwise regression to predict interpreted logging data for the original logging data; ii) determining a correlation coefficient and a root-mean-square error (RMSE) for each type of original logging data and combination of original logging data types in the preferred set of original logging data using interpreted logging data for the preferred set of original logging data and the predicted interpreted logging data for the preferred set of original logging data; iii) plotting each correlation coefficient and RMSE on a separate graph for each type of original logging data and combination of original logging data types in the preferred set of original logging data; iv) plotting the interpreted logging data and each respective predicted interpreted logging data, as a function of depth, on a separate graph for each type of original logging data and combination of original logging data types in the preferred set of original logging data; and v) selecting a best set of original logging data in the preferred set of original logging data based on one or more of the plotted graphs.

In yet another embodiment, the present disclosure includes A non-transitory program carrier device tangibly carrying computer executable instructions for selecting logging data for petrophysical modelling and completion optimization, the instructions being executable to implement: i) determining a preferred set of original logging data from original logging data using stepwise regression to predict interpreted logging data for the original logging data; ii) determining at least one of a correlation coefficient and a root-mean-square error (RMSE) for each type of original logging data and combination of original logging data types in the preferred set of original logging data using interpreted logging data for the preferred set of original logging data and the predicted interpreted logging data for the preferred set of original logging data; iii) plotting at least one of each correlation coefficient and RMSE on a separate graph for each type of original logging data and combination of original logging data types in the preferred set of original logging data; iv) plotting the interpreted logging data and each respective predicted interpreted logging data, as a function of depth, on a separate graph for each type of original logging data and combination of original logging data types in the preferred set of original logging data; v) displaying each plotted graph; and selecting a best set of original logging data in the preferred set of original logging data based on one or more of the plotted graphs.

The subject matter of the present disclosure is described with specificity, however, the description itself is not intended to limit the scope of the disclosure. The subject matter thus, might also be embodied in other ways, to include different structures, steps and/or combinations similar to those described herein in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the present disclosure is described in connection with the oil and gas industry, it is not limited thereto and may also be applied in other industries (e.g. drilling water wells) to achieve similar results.

### Method Description

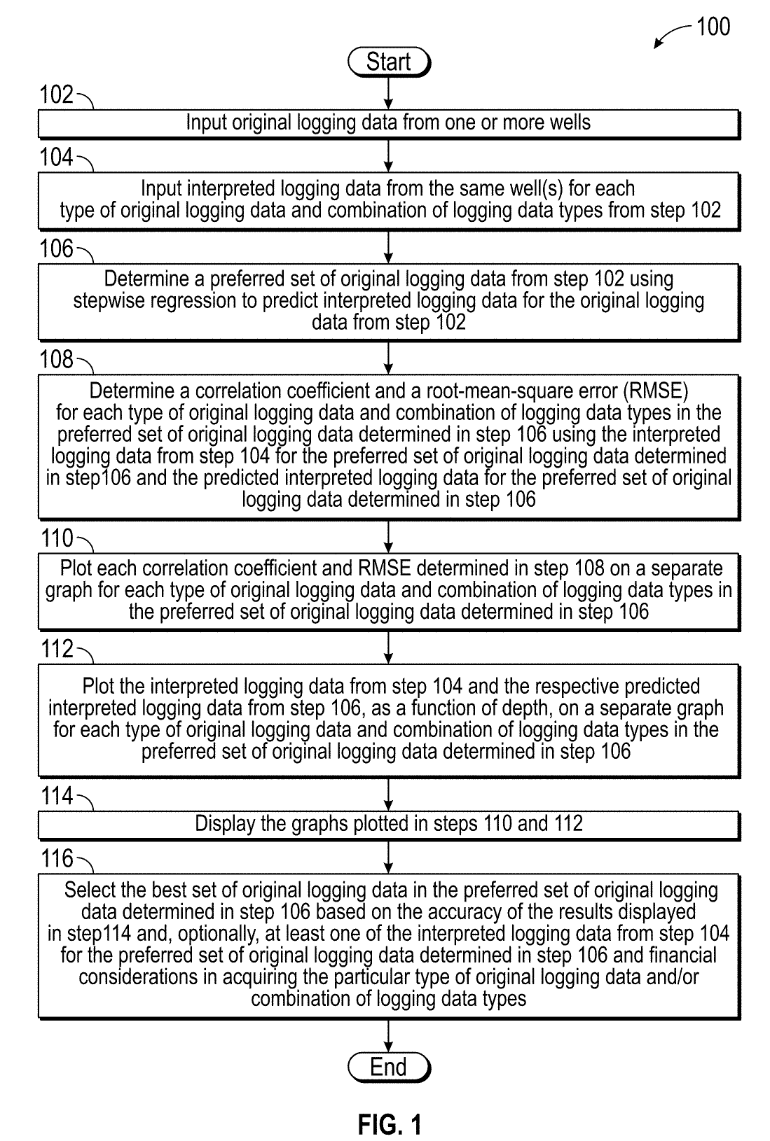

Referring now to FIG. 1, a flow diagram illustrates one embodiment of a method 100 for implementing the present disclosure. The method 100 is useful for selecting the best log measurements for formation evaluation that would contribute to successful completion optimization.

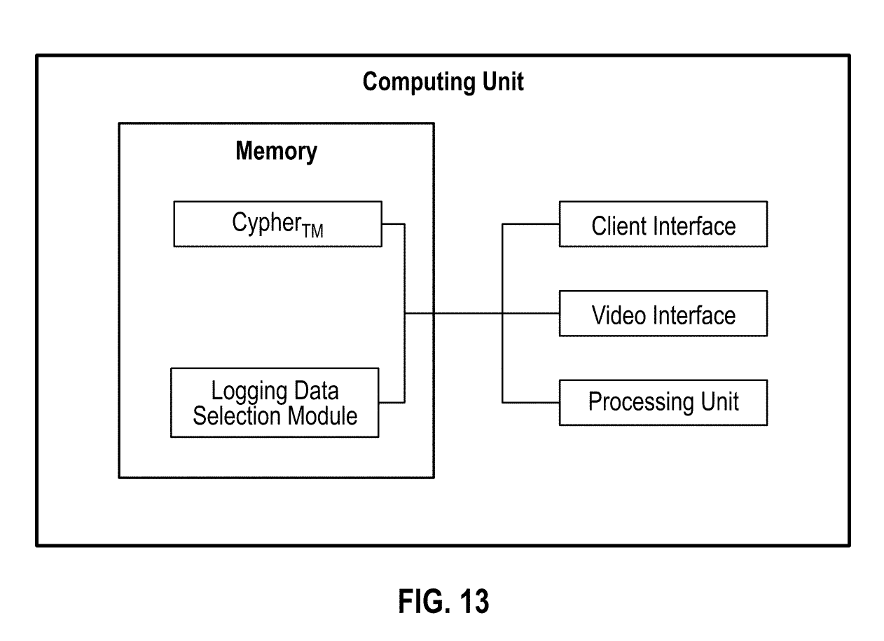

In step 102, original logging data from one or more wells is input using the client interface and/or the video interface described further in reference to FIG. 13. Exemplary original logging data may include, for example, Gamma Ray (GR), compressional and shear sonic slowness (DTC and DTS), spectral Gamma Ray (SGR), Bulk Density (RHOB), Neutron Porosity (NPHI), Thorium (Th), Potassium (K) and Uranium (U) logs. The original logging data may be input as a single type of logging data (e.g. GR) or as a combination of logging data types (e.g. TH, K, U).

In step 104, interpreted logging data for the same well(s) used for the original logging data in step 102 is input for each type of original logging data and combination of logging data types from step 102 using the client interface and/or the video interface described further in reference to FIG. 13. Exemplary interpreted logging data may include, for example, Total Organic Carbon (TOC), effective porosity (PHIE), clay volume (VClay), Brittleness (Brit.), Young's Modulus (YM), Production Index (PI), Fracture Index (FI) and Ductile Fraction (DF). The interpreted logging data is based on a calibration to measured core sample data and may be considered useful for selecting the optimal zones for hydraulic fracturing.

In step 106, a preferred set of original logging data from step 102 is determined by using stepwise regression to predict interpreted logging data for the original logging data from step 102. The preferred set of original logging data may be the same original logging data from step 102 or a subset thereof. Stepwise regression is a well-known statistical technique for multi-dimensional regression analysis, which is done usually based on F-tests or T-test. The main steps in stepwise regression are forward selection and backward elimination. In forward selection, there are no variables in the model and the first variable that contributes the most to prediction of the output is determined. Then each other variable is determined in the order of its contribution. Backward elimination involves starting with all candidate variables, and then determining the variables to be deleted based on a chosen model comparison criterion. Deleting the selected variable should improve the model the most. This process is repeated until no further improvement is possible. Stepwise regression can tell how much information each measurement contributes to the predictions. Because stepwise regression does not test all permutations, other statistical techniques may be used instead.

In step 108, a correlation coefficient and a root-mean-square error (RMSE) are determined for each type of original logging data and combination of logging data types in the preferred set of original logging data determined in step 106 using the interpreted logging data from step 104 for the preferred set of original logging data determined in step 106, the predicted interpreted logging data for the preferred set of original logging data determined in step 106 and techniques well known in the art for determining a correlation coefficient and an RMSE.

In step 110, each correlation coefficient determined in step 108 is plotted on a graph for each type of original logging data and combination of logging data types in the preferred set of original logging data determined in step 106 and each RMSE determined in step 108 is plotted on another graph for each type of original logging data and combination of logging data types in the preferred set of original logging data determined in step 106.

In step 112, the interpreted logging data from step 104 and the respective predicted interpreted logging data from step 106 are plotted, as a function of depth, on a separate graph for each type of original logging data and combination of logging data types in the preferred set of original logging data determined in step 106.

In step 114, the graphs plotted in steps 110 and 112 are displayed using the client interface and/or the video interface described further in reference to FIG. 13.

In step 116, the best set of original logging data in the preferred set of original logging data determined in step 106 is selected based on the accuracy of the results displayed in step 114 and, optionally, at least one of the interpreted logging data from step 104 for the preferred set of original logging data determined in step 106 and financial considerations in acquiring the particular type of original logging data and/or combination of logging data types. The best set of original logging data may be the same preferred set of original logging data from step 106 or a subset thereof.

### EXAMPLE

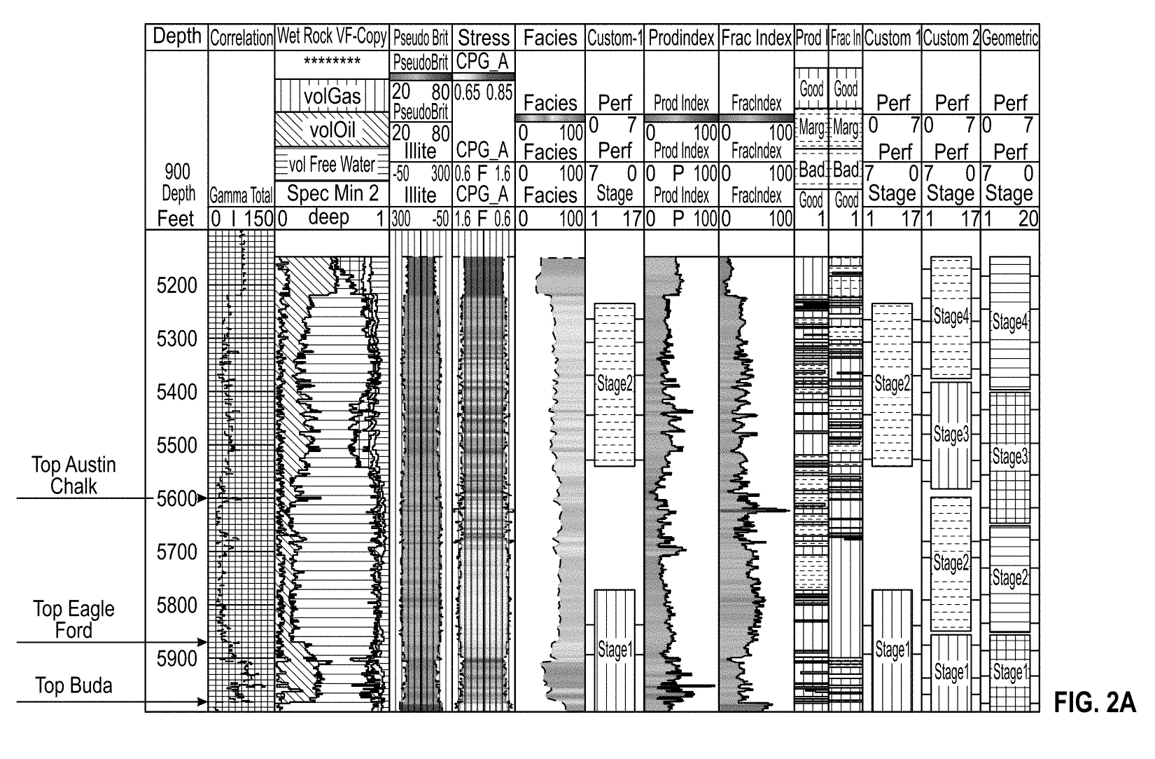

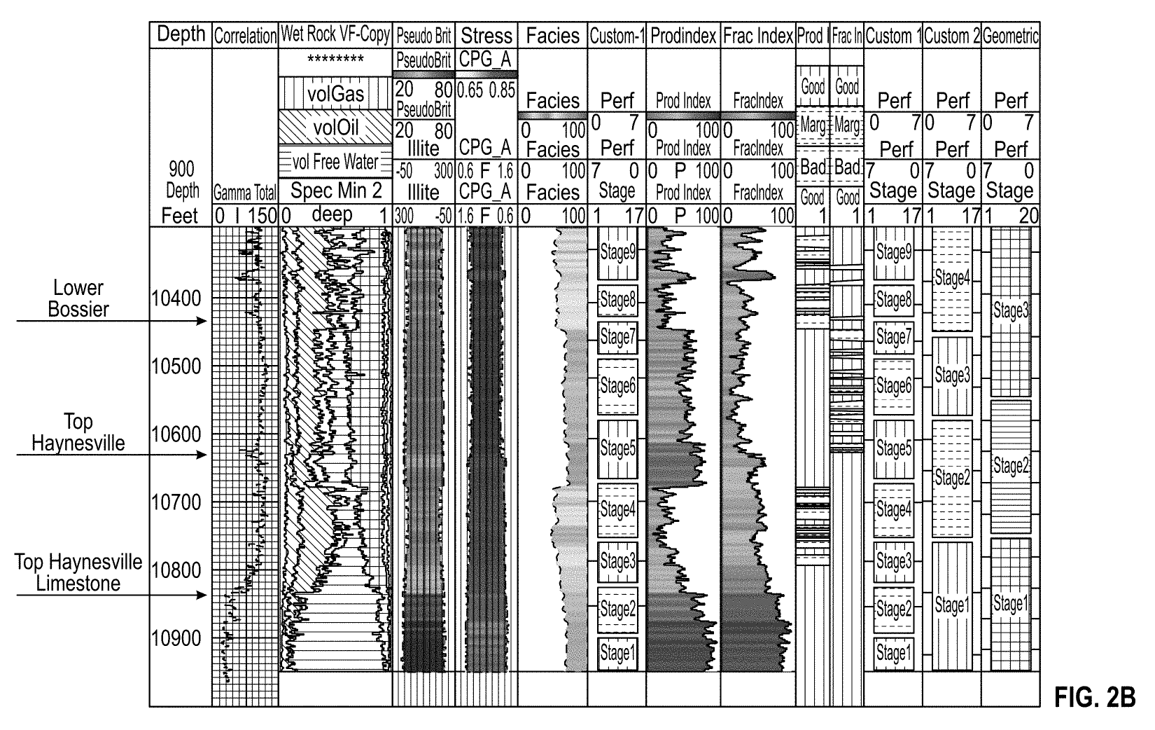

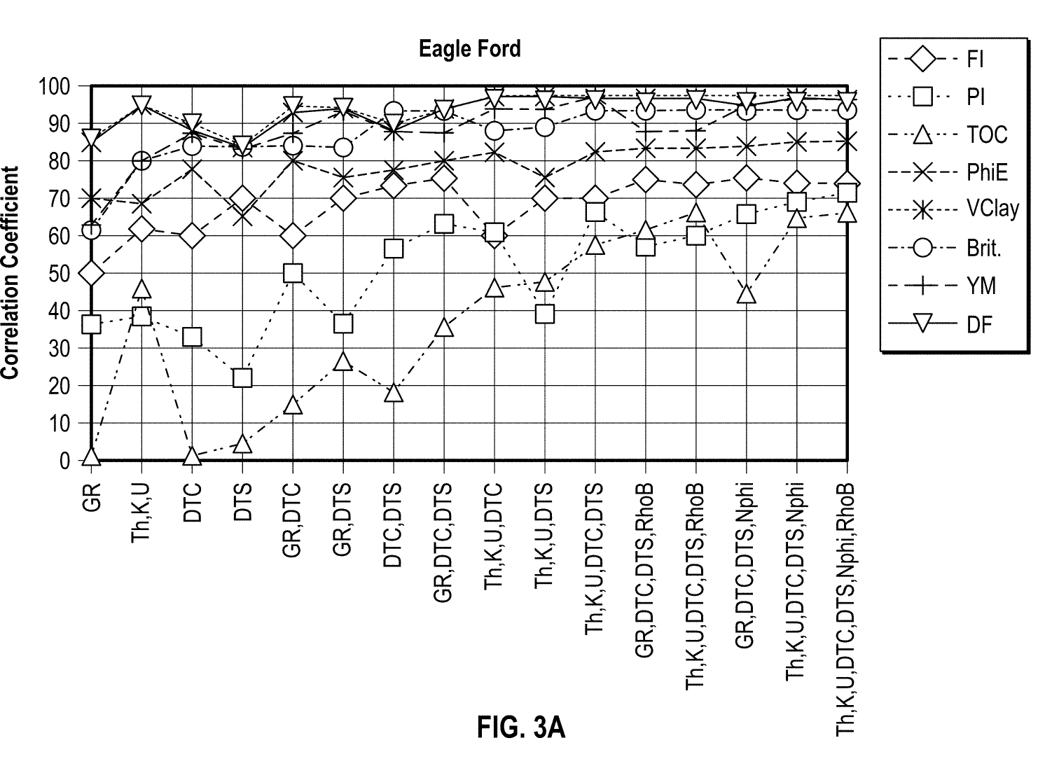

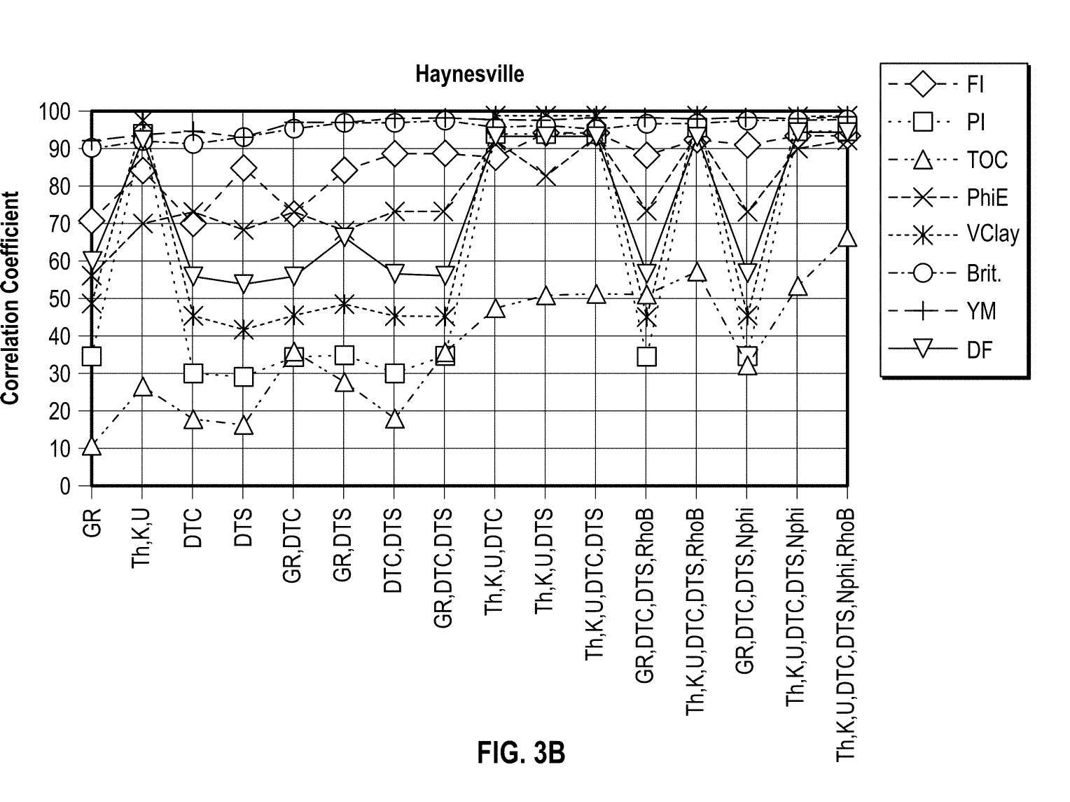

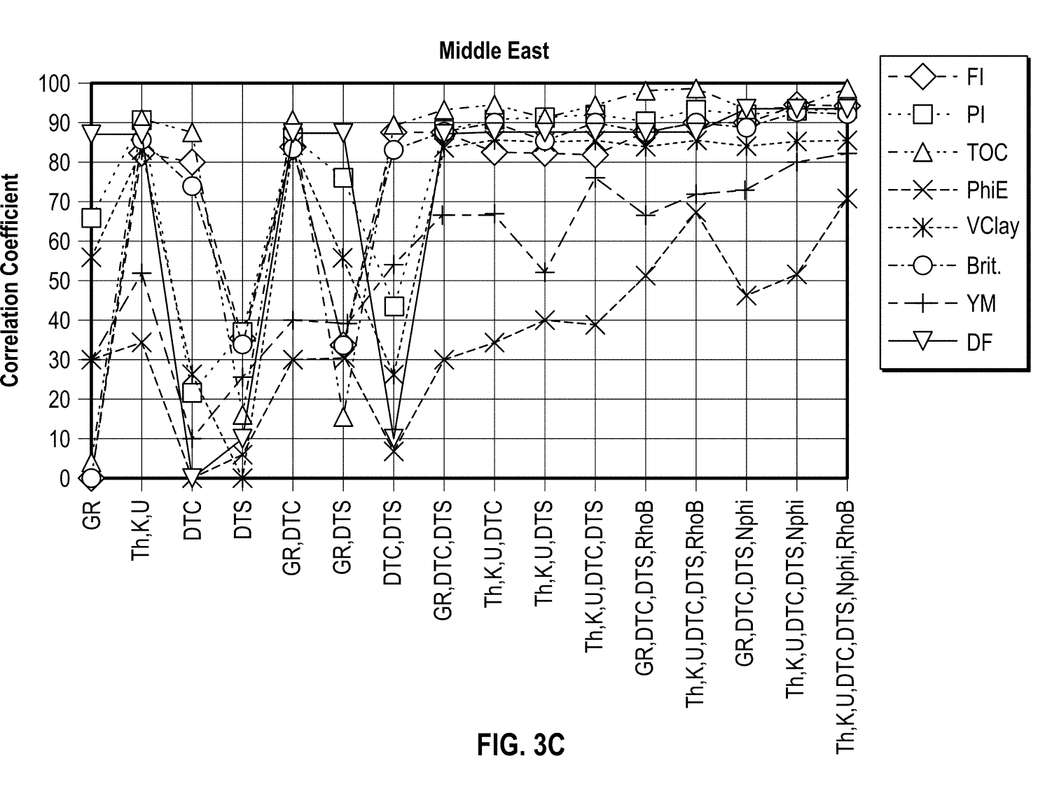

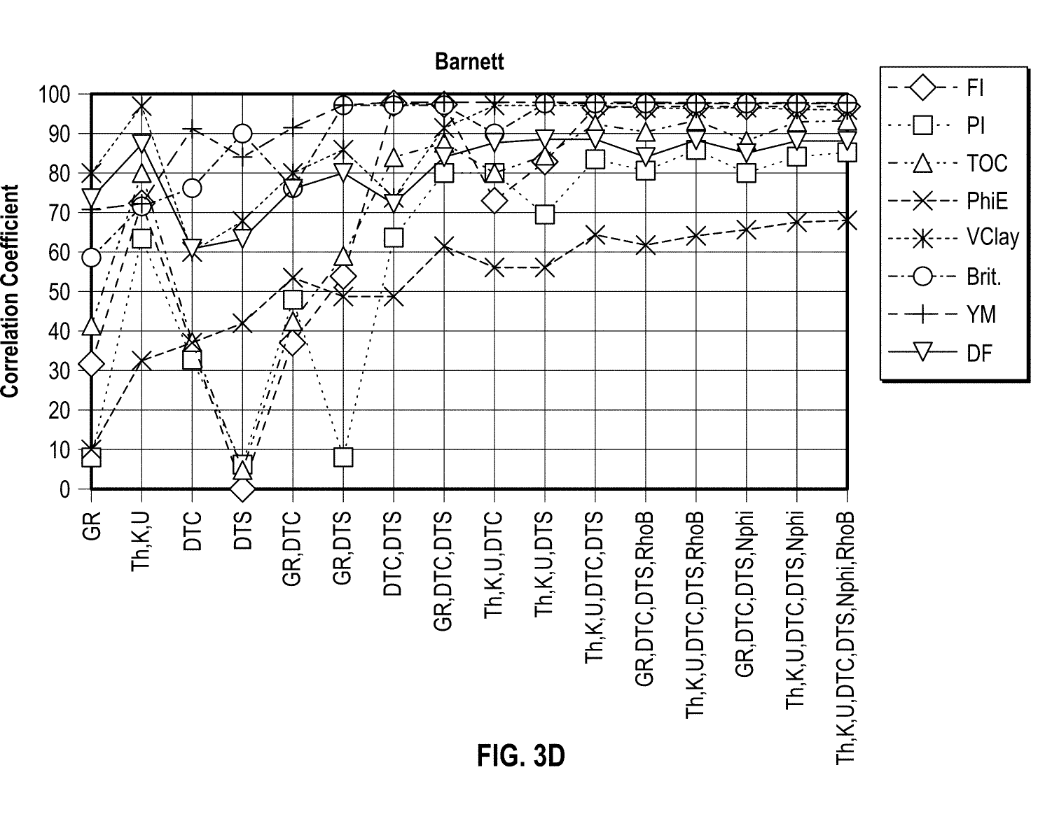

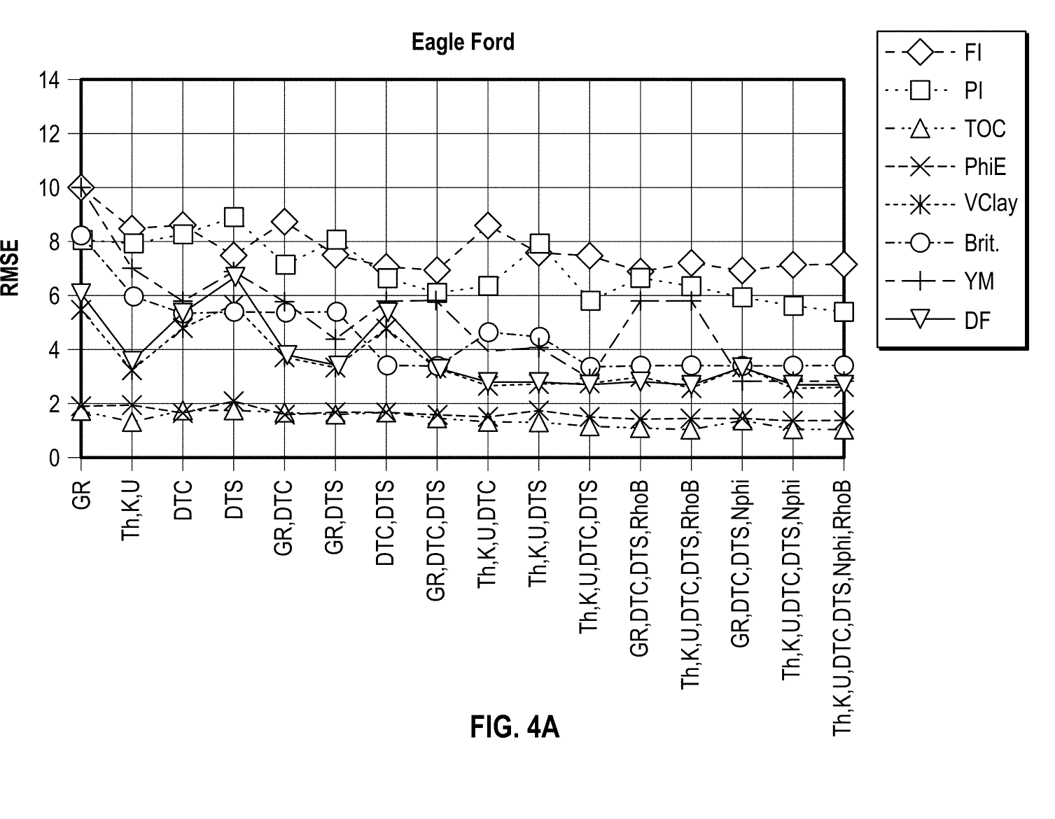

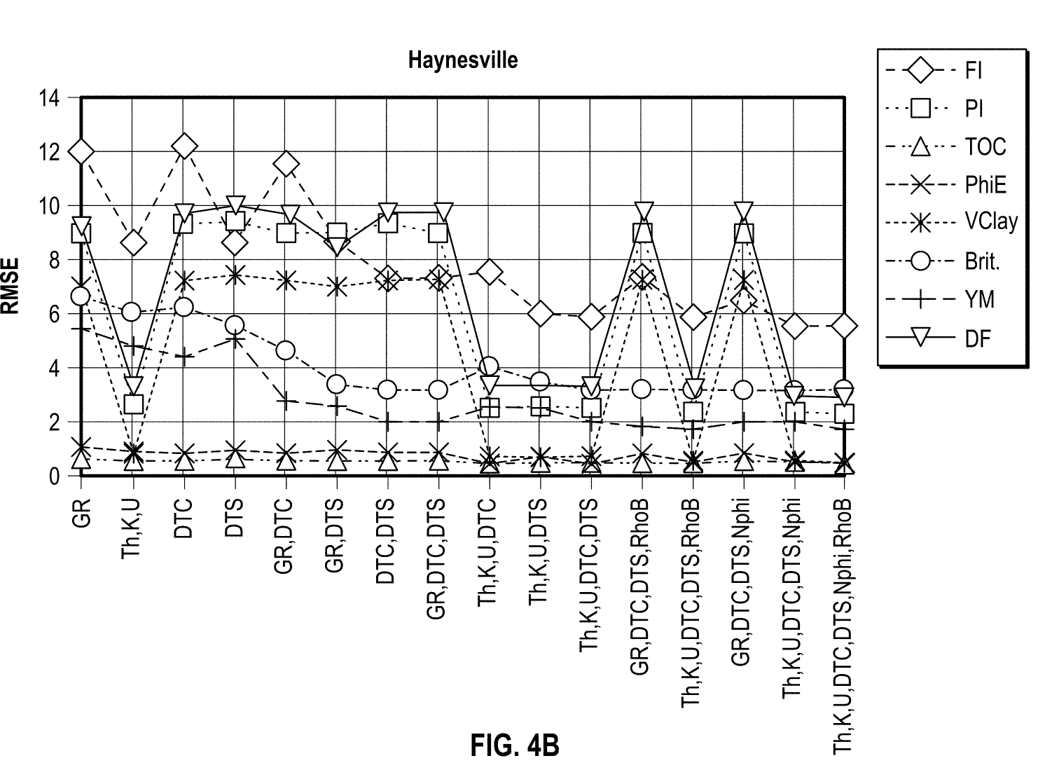

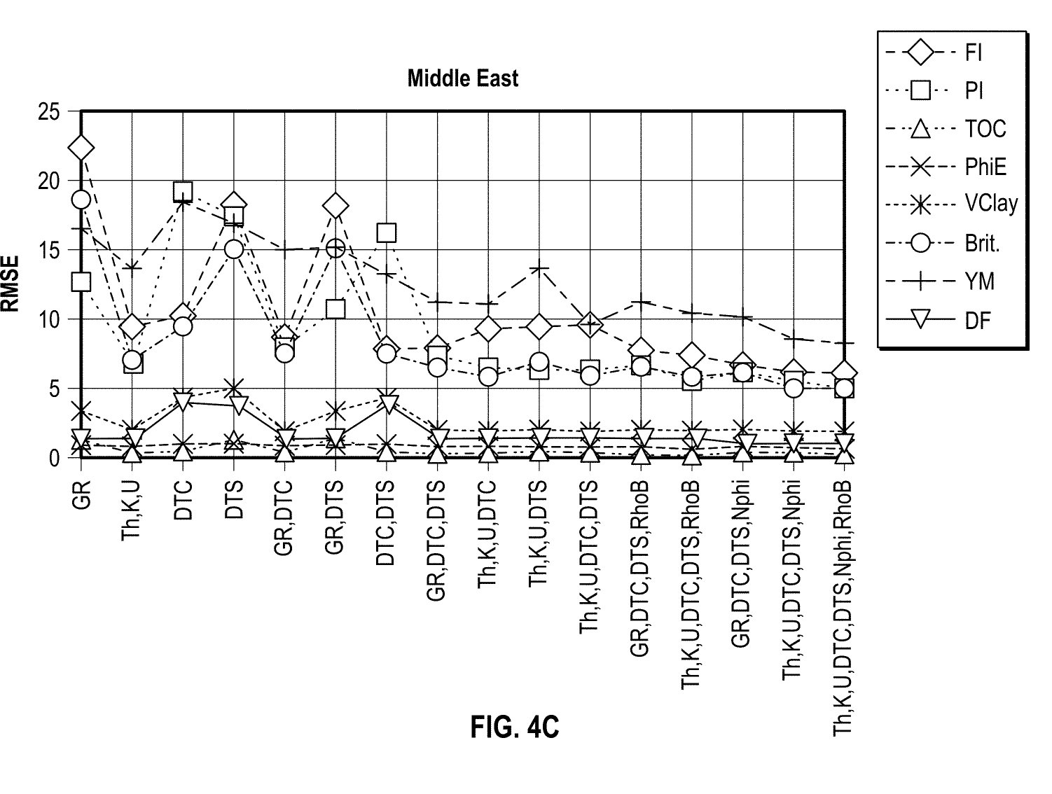

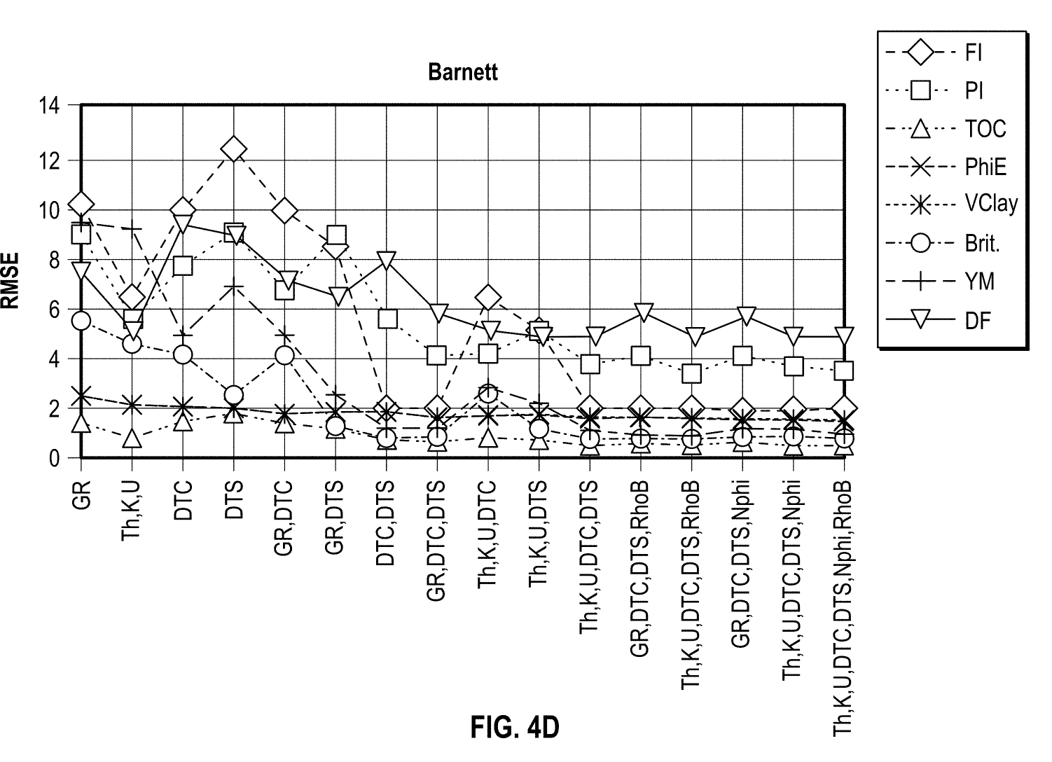

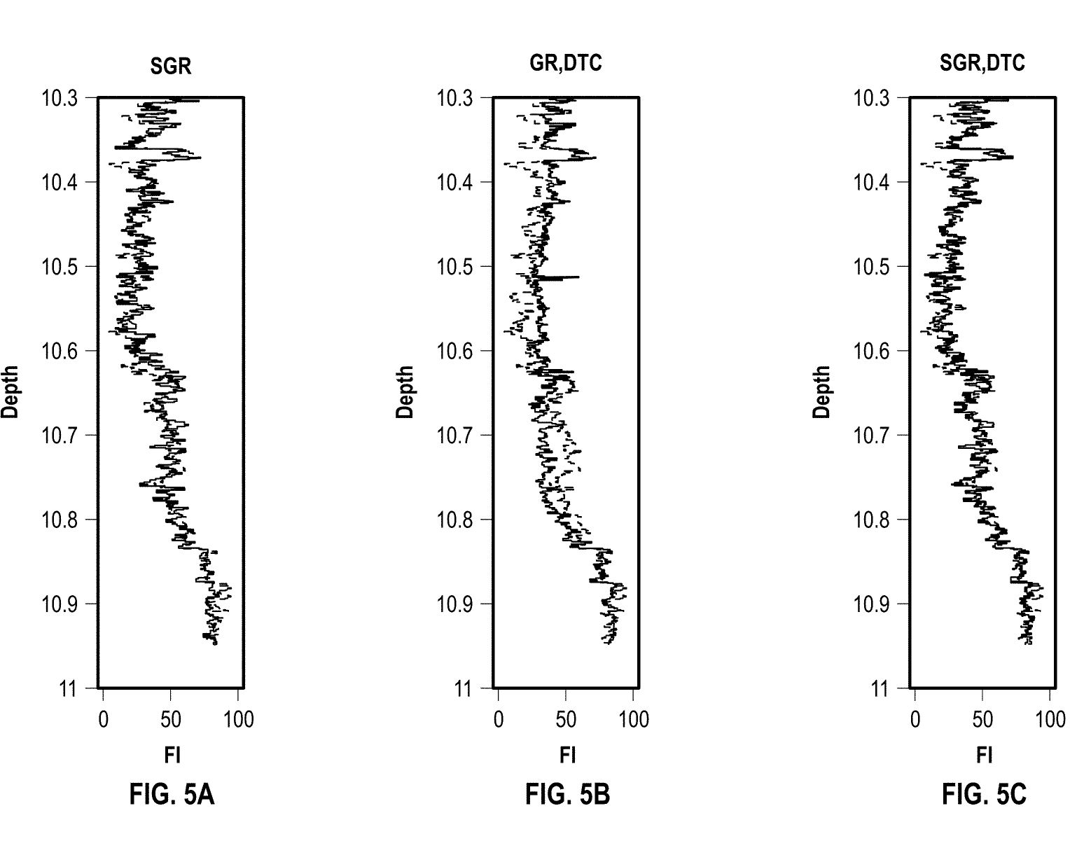

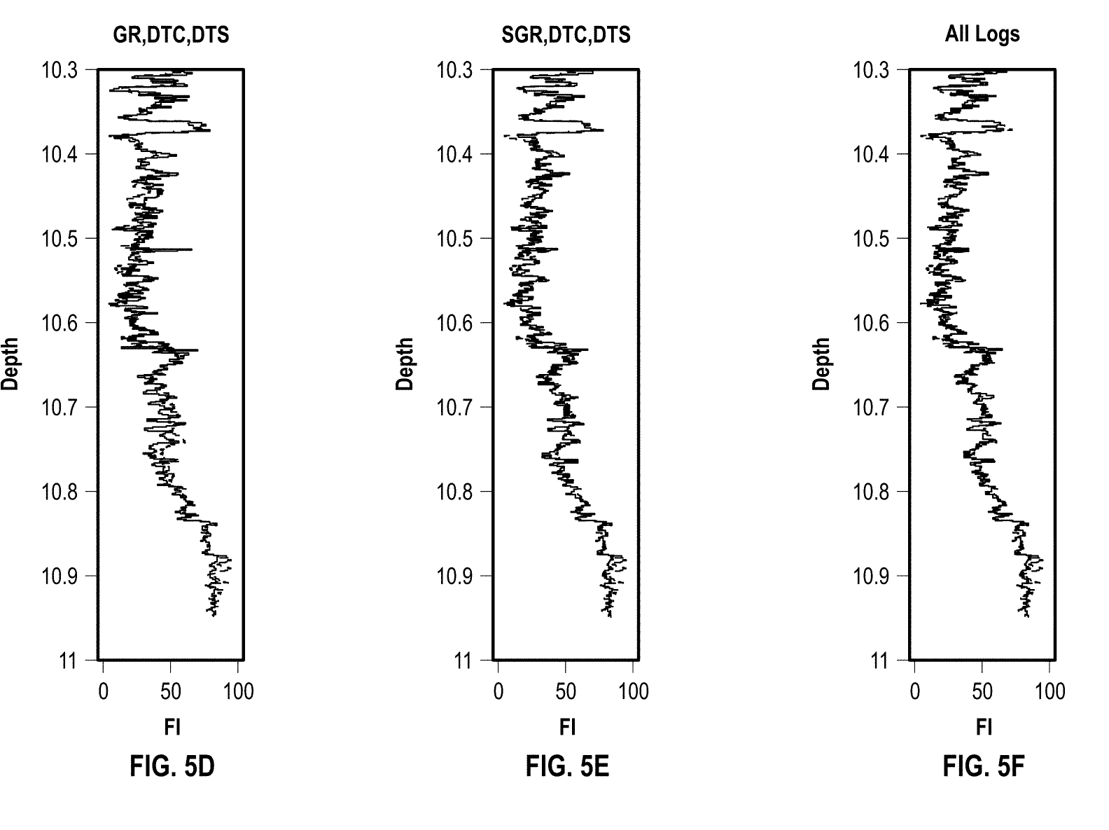

In this example, original logging data from one or more wells in the Eagle Ford, Haynesville and Barnett formations, as well as a formation from the Middle East, was used as input in step 102. Interpreted logging data for the same well(s) used for the original logging data in step 102 was used as input in step 104. FIGS. 2A and 2B are log plots illustrating the interpreted logging data for the same well(s) from the Eagle Ford and Haynesville formations, respectively. In step 106, a preferred set of original logging data from step 102 was determined by using stepwise regression to predict interpreted logging data for the original logging data from step 102. The preferred set of original logging data includes three (3) single type original logging data and thirteen (13) different combinations of logging data types for a total of sixteen (16) different scenarios that were tested. In step 108, a correlation coefficient and an RMSE were determined for each type of original logging data and combination of logging data types in the preferred set of original logging data determined in step 106 using the interpreted logging data from step 104 for the preferred set of original logging data determined in step 106, the predicted interpreted logging data for the preferred set of original logging data determined in step 106 and techniques well known in the art for determining a correlation coefficient and an RMSE. In step 110, each correlation coefficient determined in step 108 was plotted on a graph for each type of original logging data and combination of logging data types in the preferred set of original logging data determined in step 106 and each RMSE determined in step 108 was plotted on another graph for each type of original logging data and combination of logging data types in the preferred set of original logging data determined in step 106. In step 112, the interpreted logging data from step 104 and the respective predicted interpreted logging data from step 106 were plotted, as a function of depth, on a separate graph for each type of original logging data and combination of logging data types in the preferred set of original logging data determined in step 106. In step 114, the graphs plotted in step 110 are displayed for each formation in FIGS. 3A-3D (correlation coefficient) and FIGS. 4A-4D (RMSE), and the graphs plotted in step 112 are selectively displayed for only the Eagle Ford and Haynesville formations in FIGS. 5A-5F (FI), 6A-6F (PI), 7A-7F (PI), 8A-8F (TOC), 9A-9F (TOC), 10A-10F (PHIE), 11A-11F (DF), and 12A-12F (DF).

Each graph in FIGS. 3A-3D illustrates the correlation coefficient determined in step 108 for each type of original logging data and combination of logging data types in the preferred set of original logging data determined in step 106 according to the formation. Each type of original logging data and combination of logging data types are shown along the horizontal axis of each graph in FIGS. 3A-3D and the interpreted logging data/predicted interpreted logging data used are shown by the different curves noted by the legend. The correlation coefficient is shown along the horizontal axis of each graph in FIGS. 3A-3D.

Each graph in FIGS. 4A-4D illustrates the RMSE determined in step 108 for each type of original logging data and combination of logging data types in the preferred set of original logging data determined in step 106 according to the formation. Each type of original logging data and combination of logging data types are shown along the horizontal axis of each graph in FIGS. 4A-4D and the interpreted logging data/predicted interpreted logging data used are shown by the different curves noted by the legend. The RMSE is shown along the horizontal axis of each graph in FIGS. 4A-4D.

As demonstrated by FIGS. 3A-3D and 4A-4D, prediction accuracies are generally increasing by increasing the number of original logging data types in a combination. However, there are interesting features that indicate the importance of specific types of original logging data. For instance, SGR appears to be crucial for modeling different rock properties (notice the peaks and troughs for each correlation coefficient and RMSE plot when SGR is used as a type of original logging data. The most challenging interpreted logging data to predict are TOC, PHIE, PI and FI. Brit. and Y are the easiest to predict.

In FIGS. 5A-5F, the interpreted logging data and the respective predicted interpreted logging data are illustrated for FI, as a function of depth, on a separate graph for each type of original logging data and combination of logging data types (i.e. SGR; GR,DTC; SGR,DTC; GR,DTC,DTS; SGR,DTC,DTS; and SGR, DTC, DTS, NPHI, RHOB(ALL LOGS)) from the Haynesville formation. The solid curves are the predicted interpreted logging data and the dashed curves are the interpreted logging data. The results can be interpreted in different ways: SGR seems to be a valuable type of original logging data instead of GR. Also DTS seems to be an important type of original logging data because once it is added to GR and DTC, prediction results improve significantly.

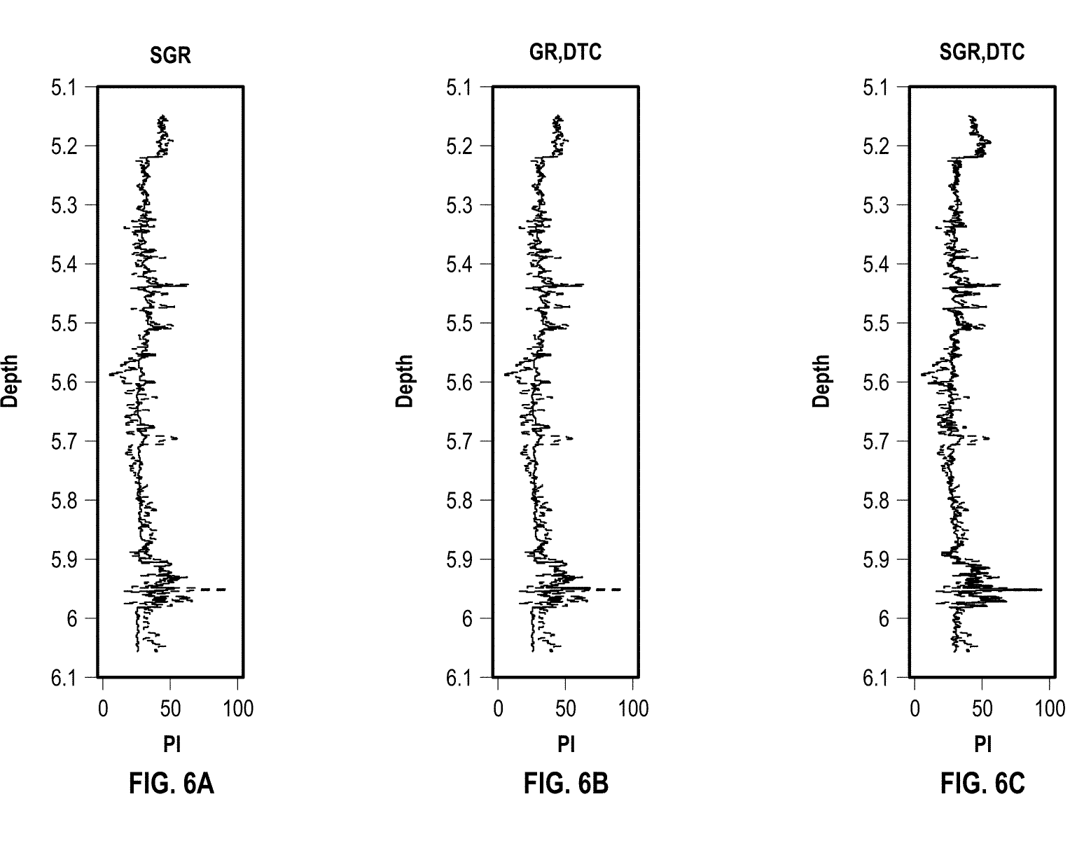

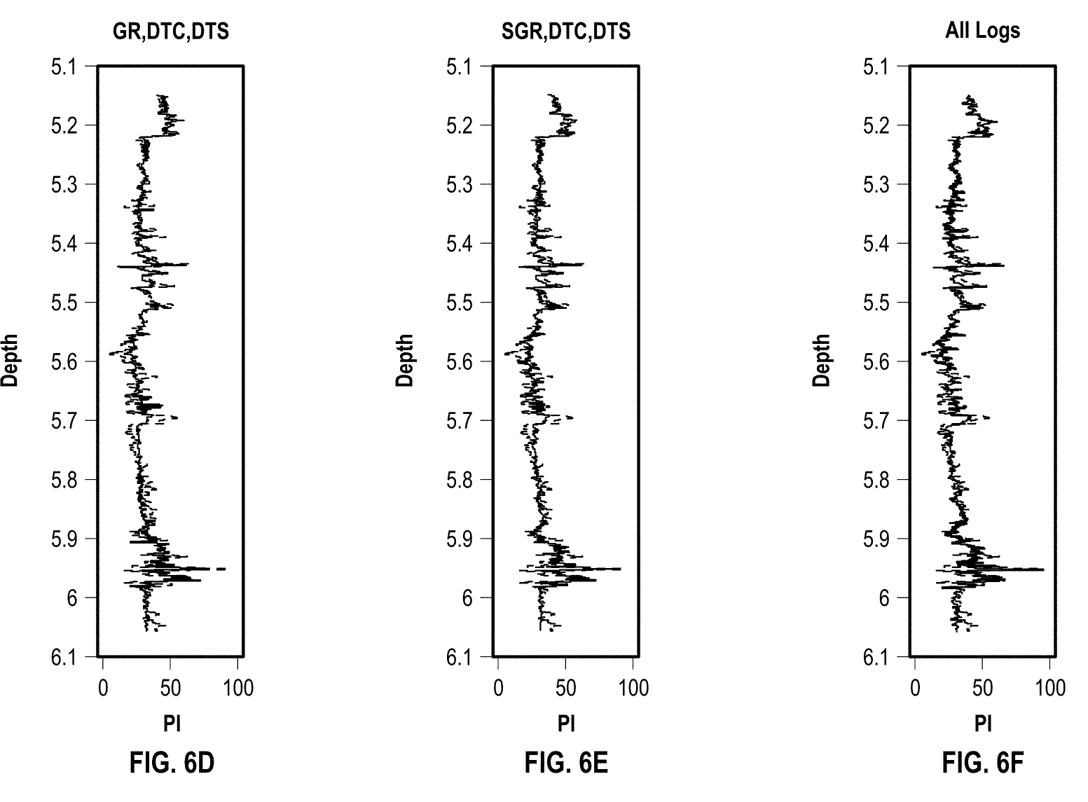

In FIGS. 6A-6F, the interpreted logging data and the respective predicted interpreted logging data are illustrated for PI, as a function of depth, on a separate graph for each type of original logging data and combination of logging data types (i.e. SGR; GR,DTC; SGR,DTC; GR,DTC,DTS; SGR,DTC,DTS; and SGR, DTC, DTS, NPHI, RHOB(ALL LOGS)) from the Eagle Ford formation. The solid curves are the predicted interpreted logging data and the dashed curves are the interpreted logging data. The results demonstrate a good prediction cannot be obtained unless a large number of original logging data types are available.

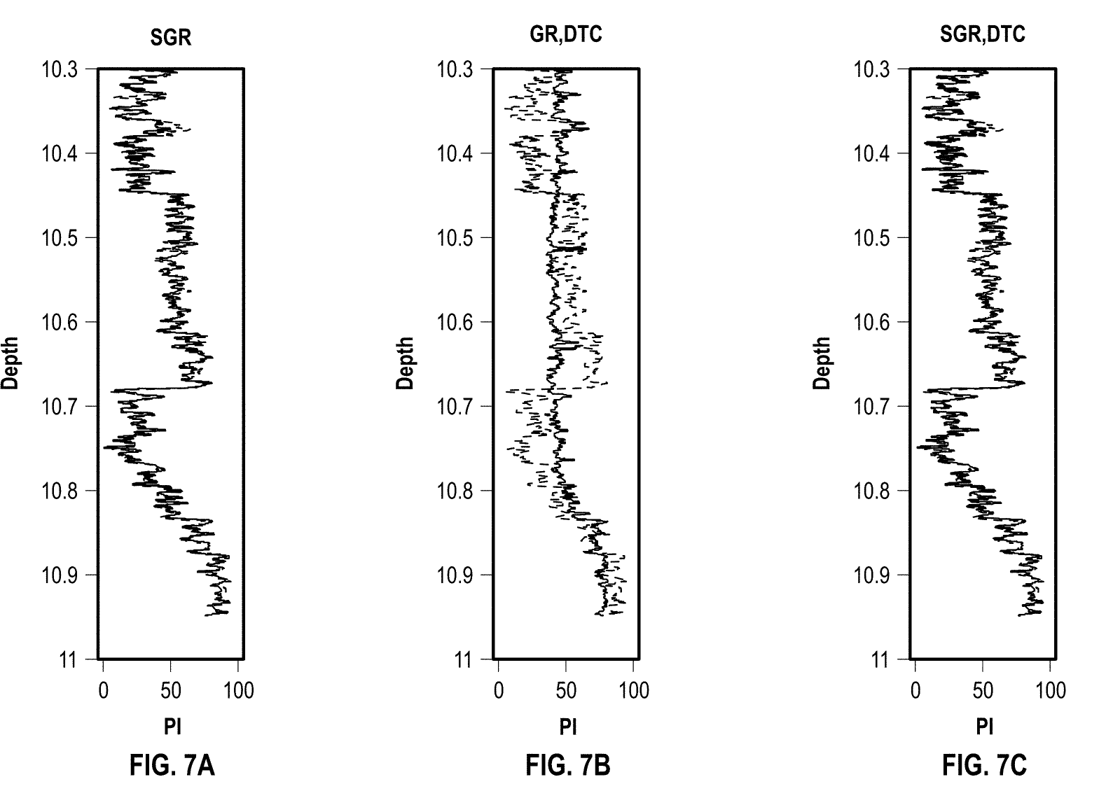

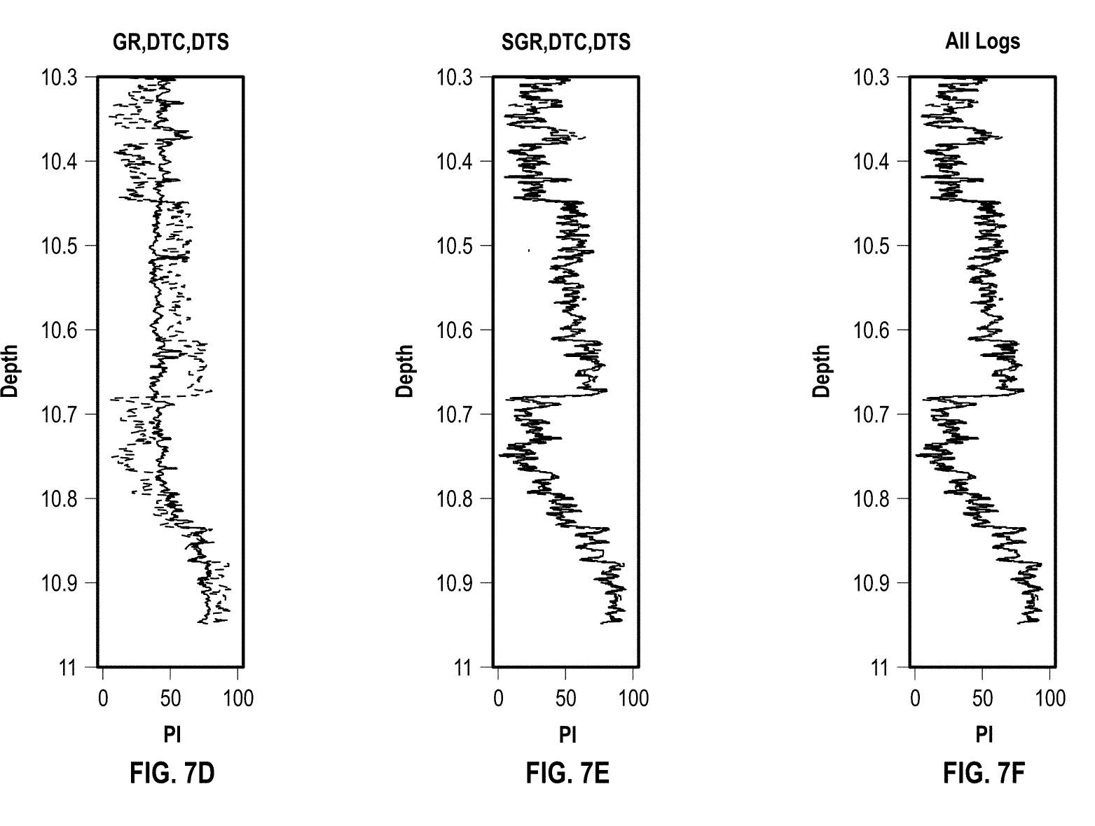

In FIGS. 7A-7F, the interpreted logging data and the respective predicted interpreted logging data are illustrated for PI, as a function of depth, on a separate graph for each type of original logging data and combination of logging data types (i.e. SGR; GR,DTC; SGR,DTC; GR,DTC,DTS; SGR,DTC,DTS; and SGR, DTC, DTS, NPHI, RHOB(ALL LOGS)) from the Haynesville formation. The solid curves are the predicted interpreted logging data and the dashed curves are the interpreted logging data. The results demonstrate that SGR seems to be dominating the predictions and clearly illustrates the preference of SGR over GR.

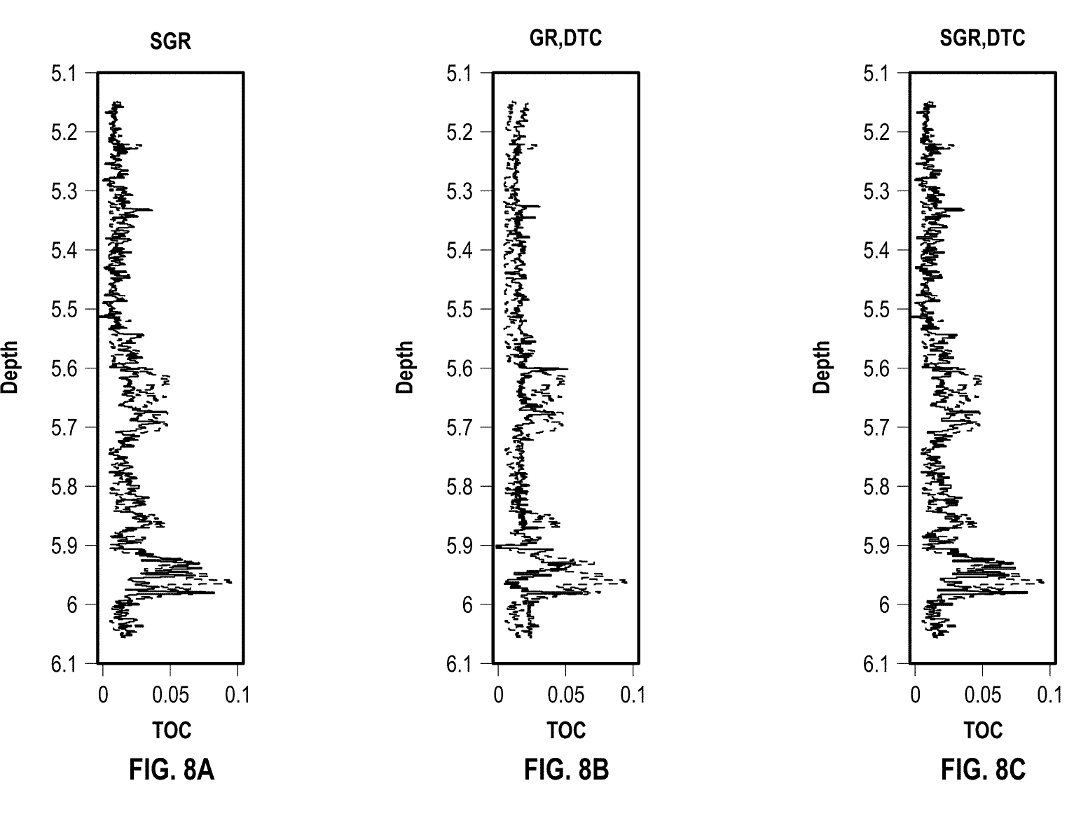

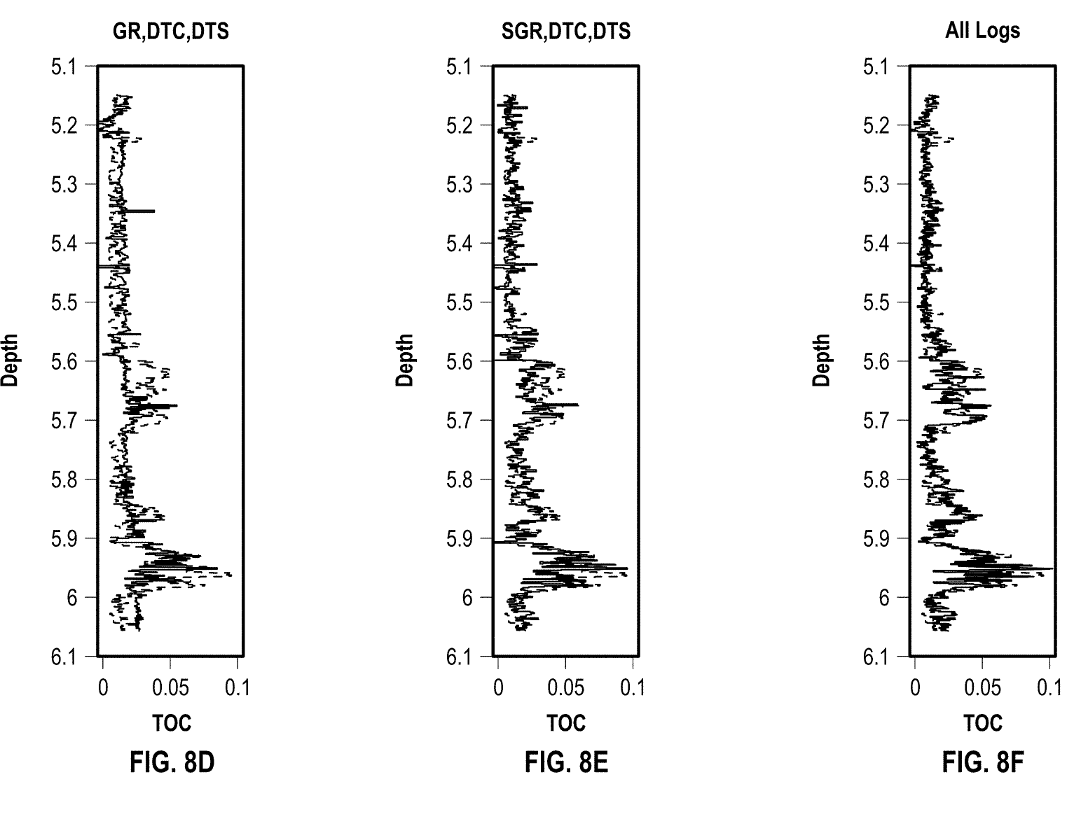

In FIGS. 8A-8F, the interpreted logging data and the respective predicted interpreted logging data are illustrated for TOC, as a function of depth, on a separate graph for each type of original logging data and combination of logging data types (i.e. SGR; GR,DTC; SGR,DTC; GR,DTC,DTS; SGR,DTC,DTS; and SGR, DTC, DTS, NPHI, RHOB(ALL LOGS)) from the Eagle Ford formation. The solid curves are the predicted interpreted logging data and the dashed curves are the interpreted logging data. The results demonstrate that SGR is again crucial for TOC predictions and the prediction accuracies improve as the number of original logging data types in a combination increases.

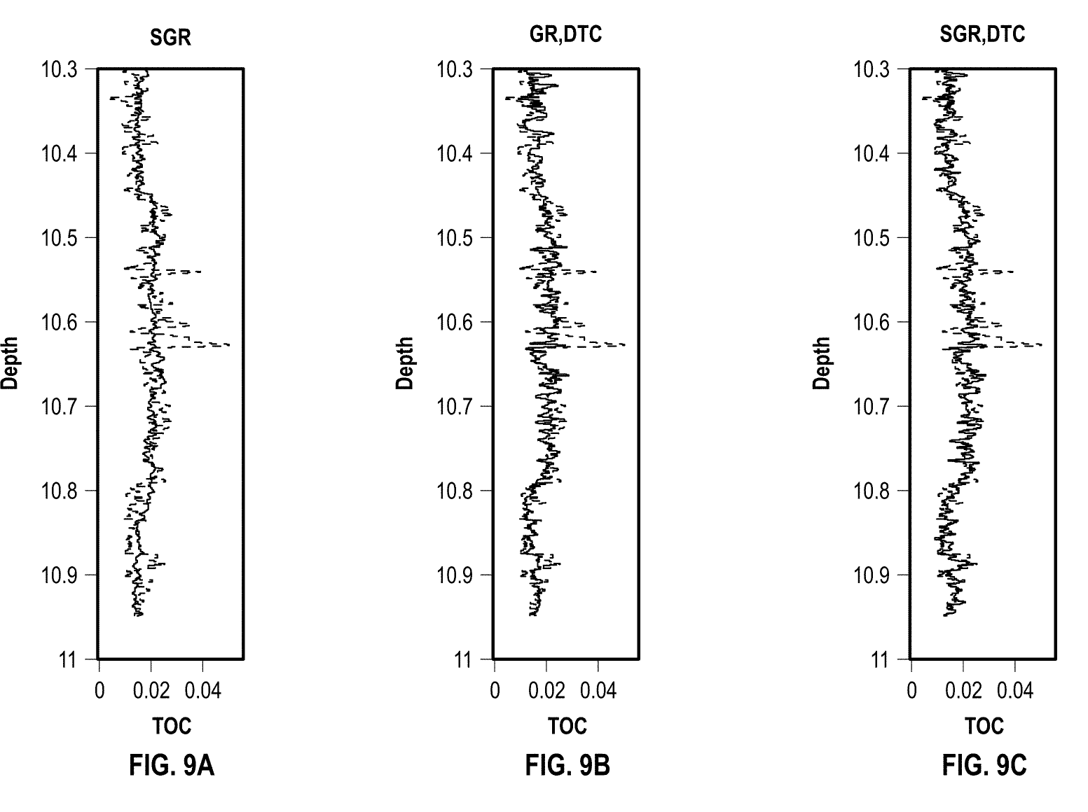

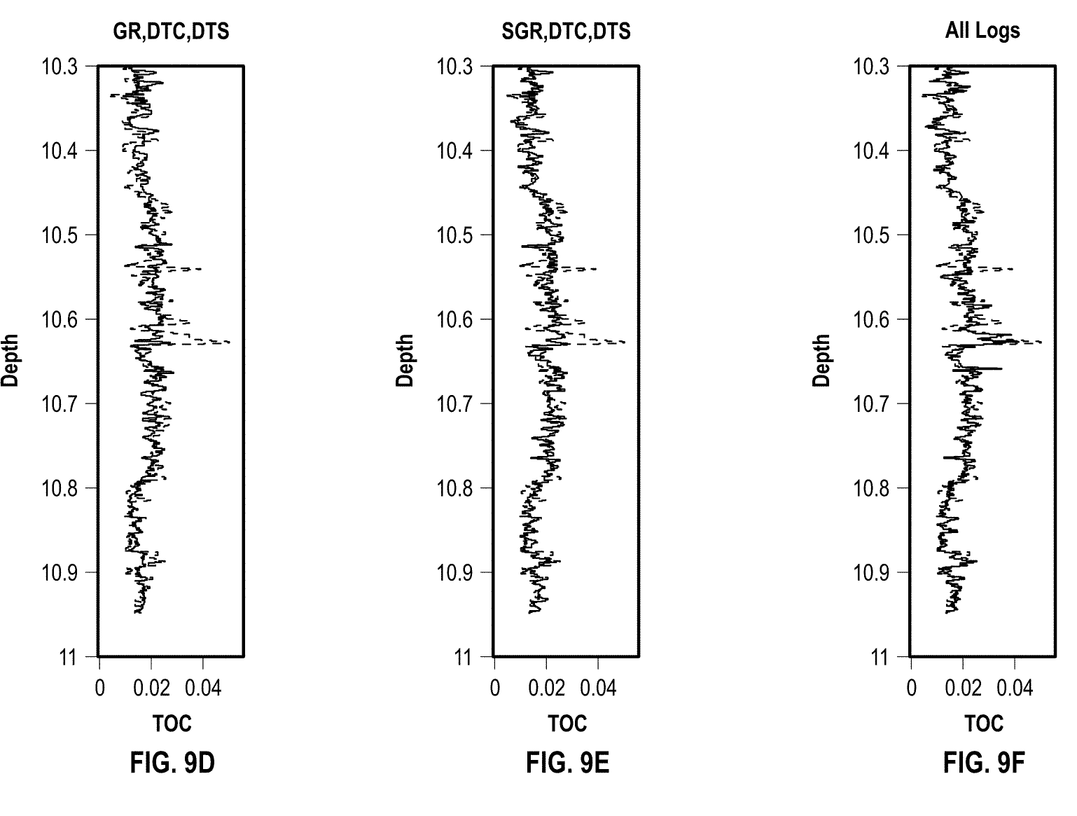

In FIGS. 9A-9F, the interpreted logging data and the respective predicted interpreted logging data are illustrated for TOC, as a function of depth, on a separate graph for each type of original logging data and combination of logging data types (i.e. SGR; GR,DTC; SGR,DTC; GR,DTC,DTS; SGR,DTC,DTS; and SGR, DTC, DTS, NPHI, RHOB(ALL LOGS)) from the Haynesville formation. The solid curves are the predicted interpreted logging data and the dashed curves are the interpreted logging data. The results demonstrate a gradual improvement can be achieved by increasing the number of original logging data types in a combination.

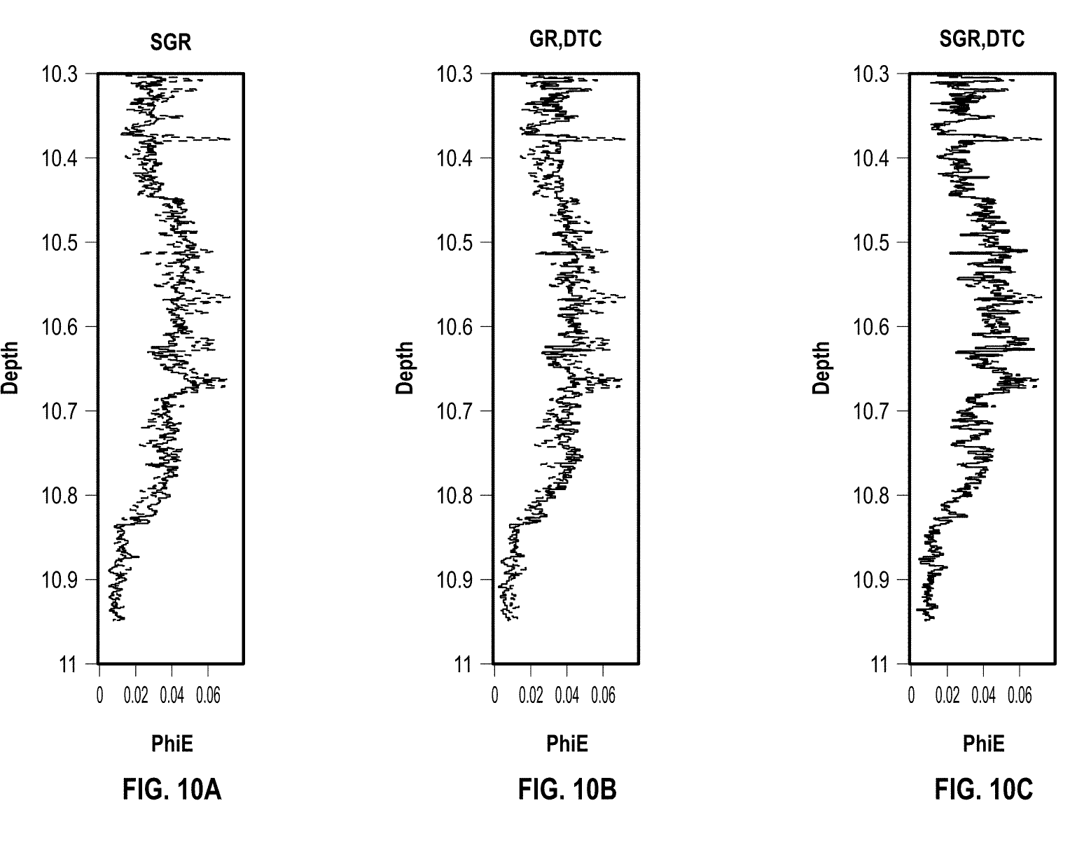

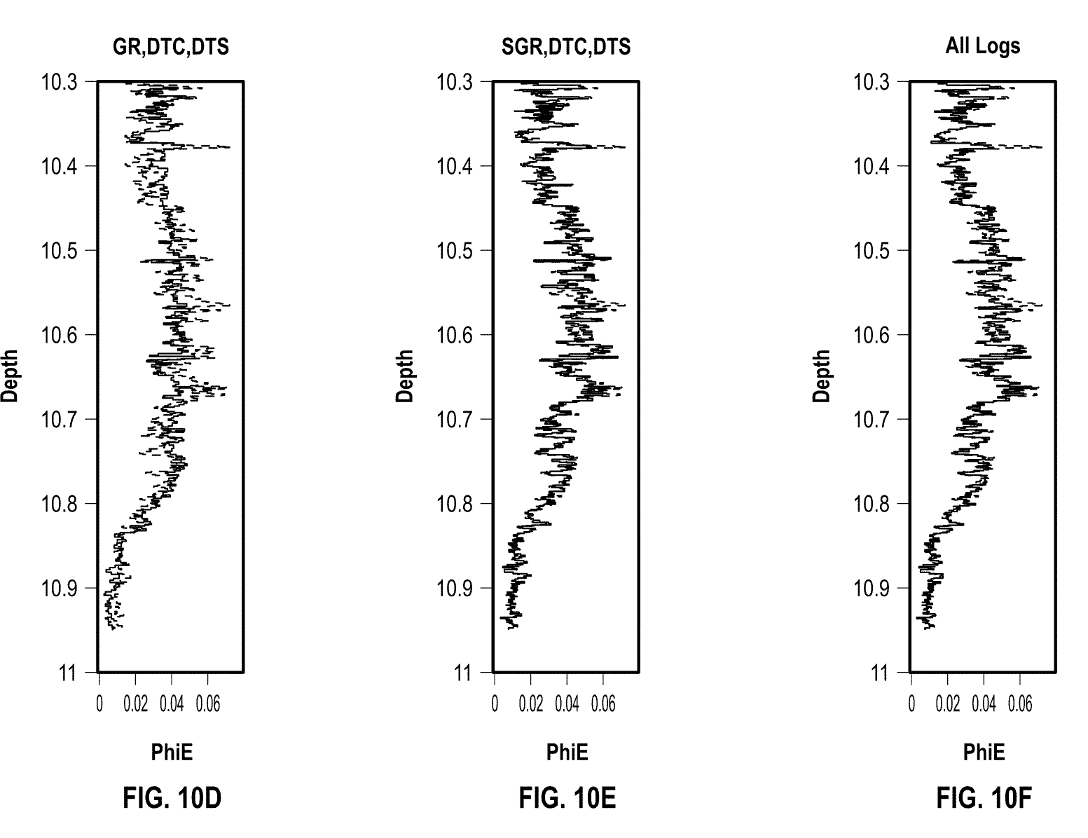

In FIGS. 10A-10F, the interpreted logging data and the respective predicted interpreted logging data are illustrated for PHIE, as a function of depth, on a separate graph for each type of original logging data and combination of logging data types (i.e. SGR; GR,DTC; SGR,DTC; GR,DTC,DTS; SGR,DTC,DTS; and SGR, DTC, DTS, NPHI, RHOB(ALL LOGS)) from the Haynesville formation. The solid curves are the predicted interpreted logging data and the dashed curves are the interpreted logging data. The results demonstrate that at least SGR and DTC are needed to predict PHIE.

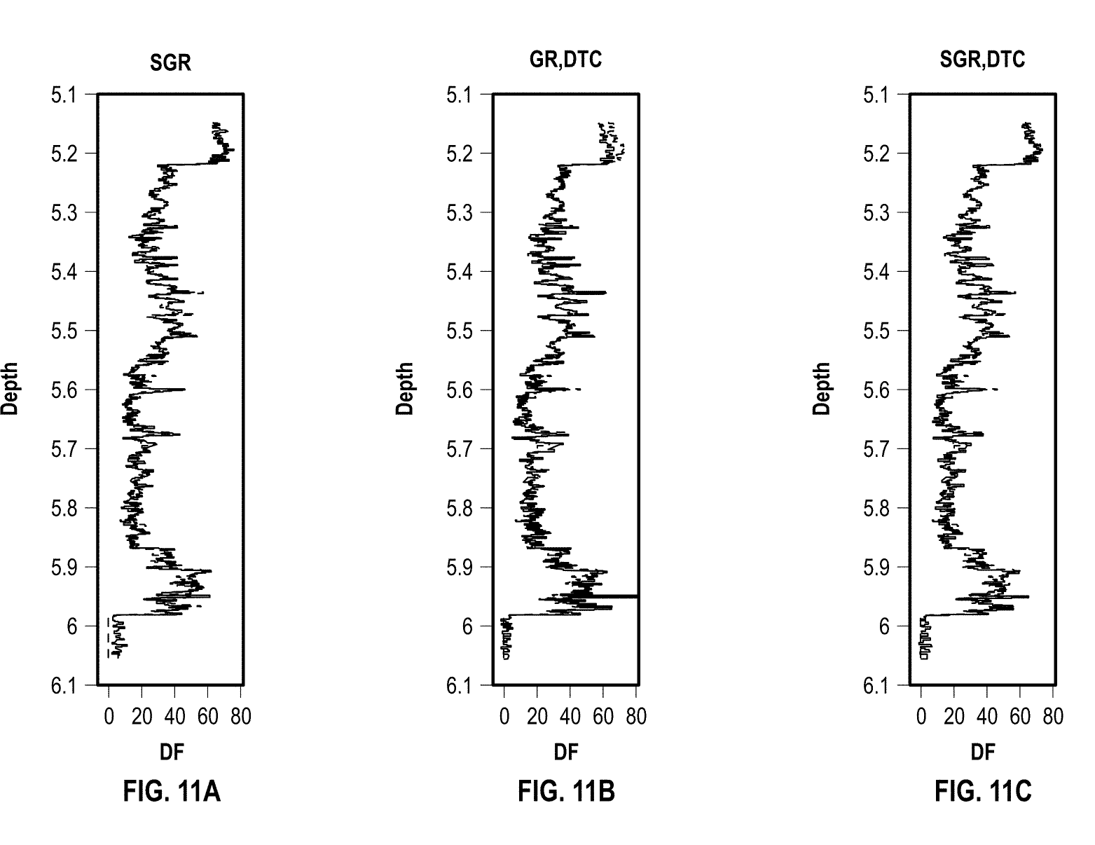

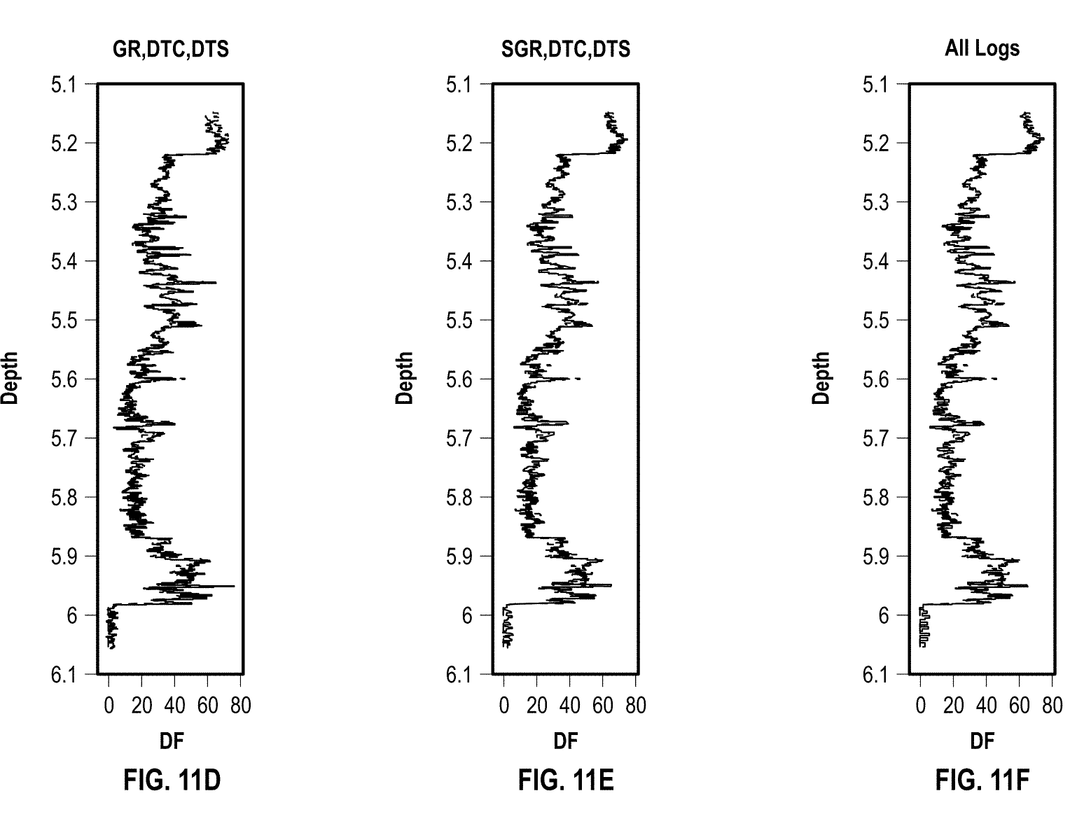

In FIGS. 11A-11F, the interpreted logging data and the respective predicted interpreted logging data are illustrated for DF, as a function of depth, on a separate graph for each type of original logging data and combination of logging data types (i.e. SGR; GR,DTC; SGR,DTC; GR,DTC,DTS; SGR,DTC,DTS; and SGR, DTC, DTS, NPHI, RHOB(ALL LOGS)) from the Eagle Ford formation. The solid curves are the predicted interpreted logging data and the dashed curves are the interpreted logging data. The results demonstrate that DF seems to be easily predicted from GR+DTC.

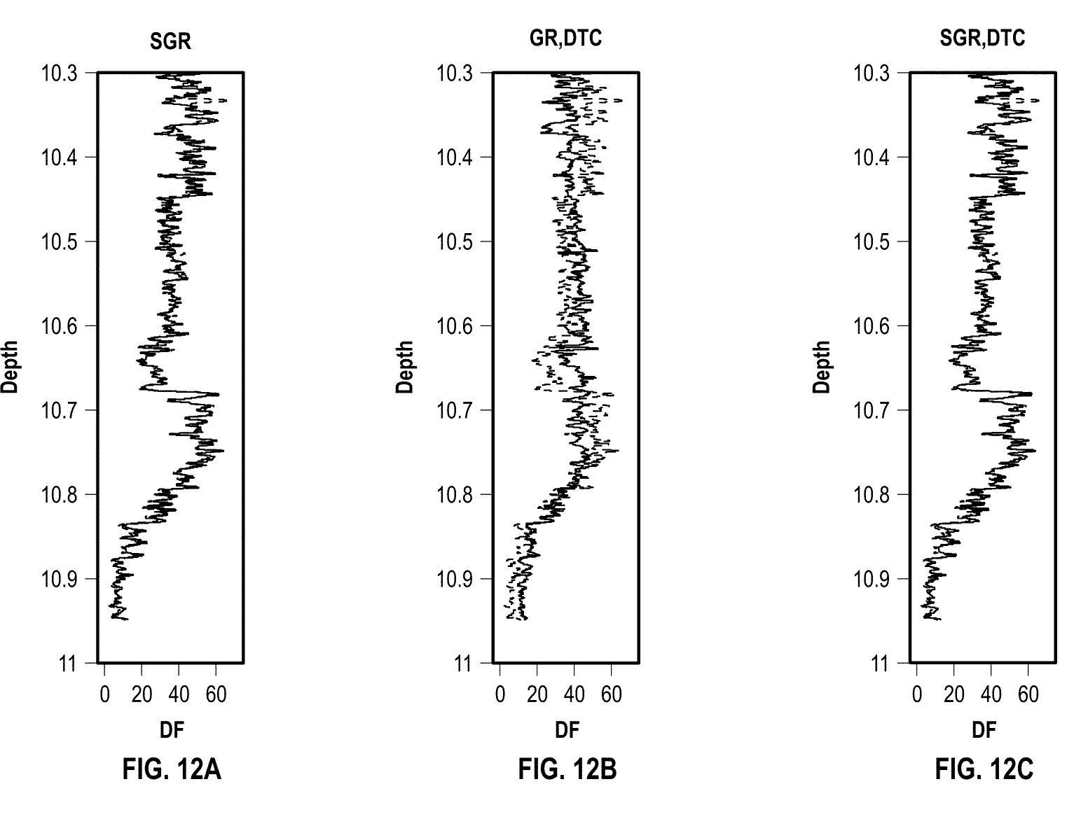

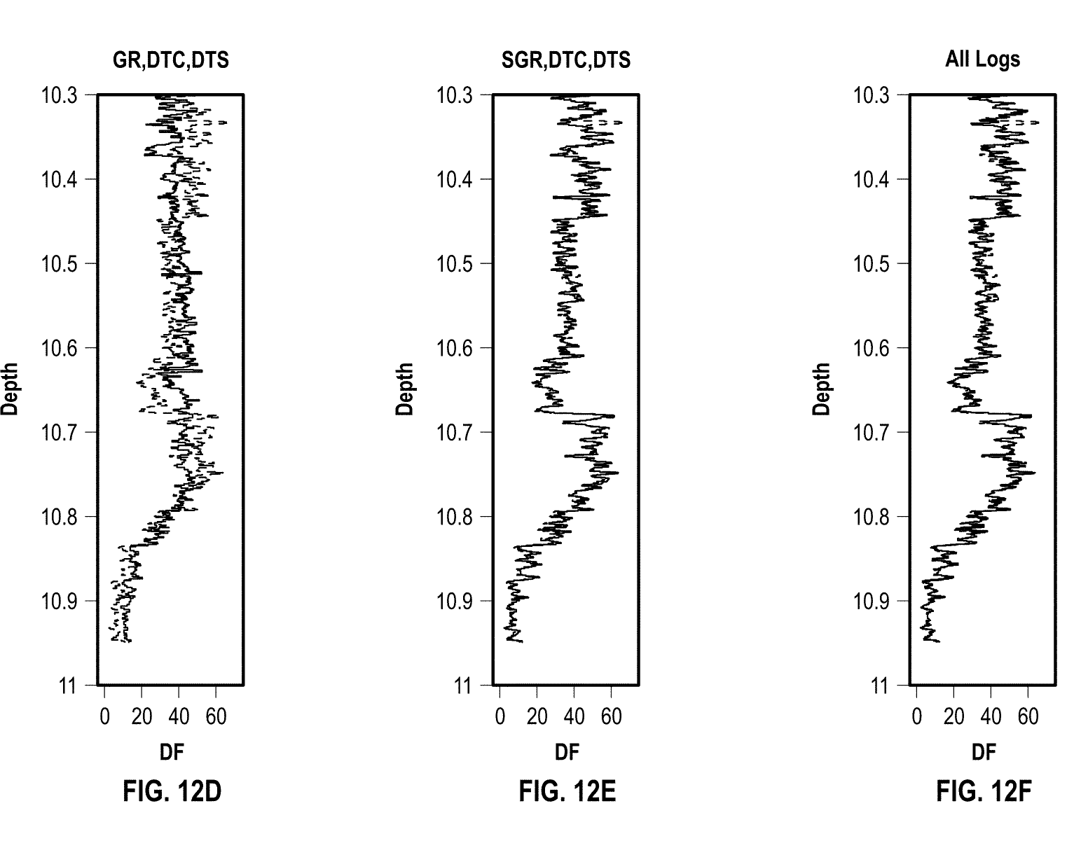

In FIGS. 12A-12F, the interpreted logging data and the respective predicted interpreted logging data are illustrated for DF, as a function of depth, on a separate graph for each type of original logging data and combination of logging data types (i.e. SGR; GR,DTC; SGR,DTC; GR,DTC,DTS; SGR,DTC,DTS; and SGR, DTC, DTS, NPHI, RHOB(ALL LOGS)) from the Haynesville formation. The solid curves are the predicted interpreted logging data and the dashed curves are the interpreted logging data. The results demonstrate that SGR is needed to successfully predict DF.

The method 100 demonstrates that SGR and DTS types of original logging data, which are not acquired routinely, are very important for more accurate petrophysical modeling. When the method 100 was performed using logs from different formations, it was discovered that the SGR and DTS type of original logging data contribute significantly to modeling of all rock properties. The method 100 therefore, demonstrates the values of different log measurements, quantitatively, that can help build more accurate petrophysical models. For the development of oil and gas fields, this is extremely useful for optimizing future wells. The method 100 may also be used to investigate the sensitivity and effectiveness of different types of original logging data to select the optimal zones for hydraulic fracturing and completion optimization. Empirical observations indicate that sensitivity to the log measurements and parameters decreases when increasing the number of original logging data types in a combination. Therefore, investigation of sensitivity and errors is of interest for completion optimization. The number of original logging data types in a combination for predicting/modeling a specific parameter can be ranked based on a comparison of reconstruction results, actual values and correlation coefficients/errors.

### System Description

The present disclosure may be implemented through a computer-executable program of instructions, such as program modules, generally referred to as software applications or application programs executed by a computer. The software may include, for example, routines, programs, objects, components and data structures that perform particular tasks or implement particular abstract data types. The software forms an interface to allow a computer to react according to a source of input. CYPHER™, which is a commercial software application marketed by Landmark Graphics Corporation, may be used as an interface application to implement the present disclosure. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g. various types of RAM or ROM). Furthermore, the software and its results may be transmitted over a variety of carrier media such as optical fiber, metallic wire and/or through any of a variety of networks, such as the Internet.

Moreover, those skilled in the art will appreciate that the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof, in a computer system or other processing system.

Referring now to FIG. 13, a block diagram illustrates one embodiment of a system for implementing the present disclosure on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the disclosure.

The memory primarily stores the application programs, which may also be described as program modules containing computer-executable instructions, executed by the computing unit for implementing the present disclosure described herein and illustrated in FIGS. 1-12. The memory therefore, includes a logging data selection module, which enables steps 106-112 and 116 described in reference to FIG. 1. The logging data selection module may integrate functionality from the remaining application programs illustrated in FIG. 13. In particular, CYPHER™ may be used as an interface application to perform steps 102-104 and 114 in FIG. 1. Although CYPHER™ may be used as interface application, other interface applications may be used, instead, or the logging data selection module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well-known.

While the present disclosure has been described in connection with presently preferred embodiments, it will be understood by those skilled in the art that it is not intended to limit the disclosure to those embodiments. It is therefore, contemplated that various alternative embodiments and modifications may be made to the disclosed embodiments without departing from the spirit and scope of the disclosure defined by the appended claims and equivalents thereof.

1. A method for selecting logging data for petrophysical modelling and completion optimization, which comprises:
determining a preferred set of original logging data from original logging data using stepwise regression and a computer processor to predict interpreted logging data for the original logging data;
determining a correlation coefficient and a root-mean-square error (RMSE) for each type of original logging data and combination of original logging data types in the preferred set of original logging data using interpreted logging data for the preferred set of original logging data and the predicted interpreted logging data for the preferred set of original logging data;
plotting each correlation coefficient and RMSE on a separate graph for each type of original logging data and combination of original logging data types in the preferred set of original logging data;
plotting the interpreted logging data and each respective predicted interpreted logging data, as a function of depth, on a separate graph for each type of original logging data and combination of original logging data types in the preferred set of original logging data; and
selecting a best set of original logging data in the preferred set of original logging data based on one or more of the plotted graphs.

2. The method of claim 1, wherein the original logging data represent at least one of a single type of logging data and a combination of original logging data types from one or more wells.

3. The method of claim 2, wherein the interpreted logging data correspond to at least one of each type of original logging data and each combination of original logging data types from the one or more wells.

4. The method of claim 1, wherein the interpreted logging data is based on a calibration to measured core sample data.

5. The method of claim 1, further comprising displaying each plotted graph.

6. The method of claim 1, further comprising acquiring the original logging data from the one or more wells.

7. The method of claim 1, wherein selecting the best set of original logging data in the preferred set of original logging data is based on the one or more plotted graphs and at least one of the interpreted logging data for the preferred set of original logging data and financial factors in acquiring a particular type of original logging data and combination of original logging data types.

8. The method of claim 2, wherein the original logging data represent SGR and DTS.

9. A non-transitory program carrier device tangibly carrying computer executable instructions for selecting logging data for petrophysical modelling and completion optimization, the instructions being executable to implement:
determining a preferred set of original logging data from original logging data using stepwise regression to predict interpreted logging data for the original logging data;
determining a correlation coefficient and a root-mean-square error (RMSE) for each type of original logging data and combination of original logging data types in the preferred set of original logging data using interpreted logging data for the preferred set of original logging data and the predicted interpreted logging data for the preferred set of original logging data;
plotting each correlation coefficient and RMSE on a separate graph for each type of original logging data and combination of original logging data types in the preferred set of original logging data;
plotting the interpreted logging data and each respective predicted interpreted logging data, as a function of depth, on a separate graph for each type of original logging data and combination of original logging data types in the preferred set of original logging data; and
selecting a best set of original logging data in the preferred set of original logging data based on one or more of the plotted graphs.

10. The program carrier device of claim 9, wherein the original logging data represent at least one of a single type of logging data and a combination of original logging data types from one or more wells.

11. The program carrier device of claim 10, wherein the interpreted logging data correspond to at least one of each type of original logging data and each combination of original logging data types from the one or more wells.

12. The program carrier device of claim 9, wherein the interpreted logging data is based on a calibration to measured core sample data.

13. The program carrier device of claim 9, further comprising displaying each plotted graph.

14. The program carrier device of claim 9, further comprising acquiring the original logging data from the one or more wells.

15. The program carrier device of claim 9, wherein selecting the best set of original logging data in the preferred set of original logging data is based on the one or more plotted graphs and at least one of the interpreted logging data for the preferred set of original logging data and financial factors in acquiring a particular type of original logging data and combination of original logging data types.

16. The program carrier device of claim 10, wherein the original logging data represent SGR and DTS.

17. A non-transitory program carrier device tangibly carrying computer executable instructions for selecting logging data for petrophysical modelling and completion optimization, the instructions being executable to implement:
determining a preferred set of original logging data from original logging data using stepwise regression to predict interpreted logging data for the original logging data;
determining at least one of a correlation coefficient and a root-mean-square error (RMSE) for each type of original logging data and combination of original logging data types in the preferred set of original logging data using interpreted logging data for the preferred set of original logging data and the predicted interpreted logging data for the preferred set of original logging data;
plotting at least one of each correlation coefficient and RMSE on a separate graph for each type of original logging data and combination of original logging data types in the preferred set of original logging data;
plotting the interpreted logging data and each respective predicted interpreted logging data, as a function of depth, on a separate graph for each type of original logging data and combination of original logging data types in the preferred set of original logging data;
displaying each plotted graph; and
selecting a best set of original logging data in the preferred set of original logging data based on one or more of the plotted graphs.

18. The program carrier device of claim 17, wherein the original logging data represent at least one of a single type of logging data and a combination of original logging data types from one or more wells.

19. The program carrier device of claim 18, wherein the interpreted logging data correspond to at least one of each type of original logging data and each combination of original logging data types from the one or more wells.

20. The program carrier device of claim 17, further comprising acquiring the original logging data from the one or more wells.
